(19) United States
(12) Patent Application Publication
(10) Pub. No.: US 2024/0202773 A1
(43) Pub. Date: Jun. 20, 2024

(54) METHOD, SYSTEM, AND COMPUTER PRODUCT FOR SELECTION AND PLACEMENT OF DIRECTED PRODUCT INFORMATION

(71) Applicant: Target Brands, Inc., Minneapolis, MN (US)

(72) Inventors: ARAVIND KUMAR KOLLA, Minneapolis, MN (US); VARSHA JAISWAL, Minneapolis, MN (US); MICHIEL OPTHOF, Minneapolis, MN (US); ALEXANDRA PRUDENCIO IRIZARRY, Houston, TX (US)

(21) Appl. No.: 18/081,977

(22) Filed: Dec. 15, 2022

(51) Int. Cl. G06Q 30/0251; G06Q 30/0273

(52) U.S. Cl. CPC G06Q 30/0253; G06Q 30/0254; G06Q 30/0275

(57) ABSTRACT

Methods, systems, and computer products for placement of directed content, such as advertisements, are provided. In some examples, advertisement recommendations are received from one or more third party advertising recommendation platforms. The advertisement recommendations are for items offered for sale via the retail website. Requests and/or advertisements may be filtered, based on customer context, item availability, and the like, by a retail enterprise. The plurality of available advertisements may be mediated using a weighted reverse index model based on at least first data tracking a plurality of relevancy ranks and second data tracking a plurality of bid values, wherein each of the plurality of available advertisements corresponds to one of the plurality of relevancy ranks and one of the plurality of bid values. A predetermined number of advertisements may be provided to a customer system for display within a webpage of a retail website.

### TECHNICAL FIELD

The present application relates generally to computer data science, and in particular to methods, systems, and computer products for automatically placing directed information associated with particular products within an online context.

### BACKGROUND

With the rapid growth of online shopping and digital e-commerce, there is an increasing trend for businesses to place advertisements and other directed information associated with their products on websites, such as retail websites. A product advertisement may include an image of the product, information about the product, and a price of the product. A retail website may display a product advertisement and further allow a customer browsing the retail website to click on the advertisement. In turn, the retail website may allow the customer to purchase the advertised product. In some examples, retail websites advertise products sponsored by advertisers. An advertiser may bid for a price to have a retail website place an advertisement for the sponsored product.

A conventional method to place advertisements for products on a retail website uses third party advertisement recommendation systems. Some advertisements resulted from the advertisement recommendation systems may be for items that are irrelevant to a customer, or for items the customer is not interested in. Hence, the business selling the product loses sales to the customer. For example, the customer may leave the retail website without purchasing a product that, if shown a relevant advertisement for, the customer would have purchased. In another example, if a customer perceives an advertisement as irrelevant, the customer may go elsewhere, such as another retail website, to make a purchase. In yet another example, if a customer is not interested in an advertisement, the customer may not click on the advertisement.

Typical advertisement recommendation systems may be associated with particular advertisement placement locations on a retail website. When the website is rendered, the advertisement recommendation system may be called and provided contextual information (e.g., information about the user and/or page request, such as time of day, region, and the like, and an ad recommendation is returned. However, such advertisement recommendation systems have inherent limitations. For example, a third party advertisement recommendation system has no information regarding whether a particular product is in stock. Additionally, such third-party advertisement recommendation systems would not have significant detail regarding price, promotions, and the like. Still further, it may be the case that a retail enterprise may wish to use more than one third-party advertisement recommendation system to place recommendations at different locations within a retail website. Enterprise infrastructure for controlling the ultimate recommendation to be delivered on the retail website, accounting for the potentiality of multiple advertisement recommendation systems, and adjusted for factors that are known only to the retail enterprise, is lacking.

In view of the above and other disadvantages of existing systems, improvements are desirable.

### SUMMARY

In general, this patent document relates to an advertisement placement system that boosts brands' organic placement on retail websites while controlling the overall guest experience. More specifically, this document relates to methods and systems for (1) filtering advertisements acquired from advertisement platforms through fulfillment check, (2) ranking and selecting among fulfilled advertisements through advertisement mediation, and (3) distributing, with additional control from the retailer's end, the selected advertisements in search pages, category/browse pages, and product detail pages rendered by a customer system.

In a first aspect, methods for placing advertisements is disclosed. The method includes receiving, via a communication system, one or more advertisement requests at a computing system hosting an advertisement recommendation manager associated with a retail website of a retail enterprise. The method further includes filtering, using a rules engine, the one or more advertisement requests by the computing system. The method also includes acquiring, via an application programming interface (API), a plurality of advertisements from at least one advertising recommendation platform in response to submitting one or more filtered advertisement requests. The method further includes identifying, based at least in part on context associated with the one or more advertisement requests, a plurality of available advertisements by the computing system, and mediating, by the computing system, the plurality of available advertisements using a weighted reverse index model, the weighted reverse index model configured to be based on at least first data tracking a plurality of relevancy ranks and second data tracking a plurality of bid values, wherein each of the plurality of available advertisements corresponds to one of the plurality of relevancy ranks and one of the plurality of bid values. The method includes distributing, by the computing system and via the communication system, a predetermined number of selected advertisements to a customer system within a webpage of the retail enterprise in response to mediating the plurality of available advertisements.

In a further aspect, a system for is provided. The system includes an input device, a memory device, a processing device in communication with the memory device, and an output device. The processing device is configured to receive, via the input device, a plurality of advertisement requests for advertisements to be placed within a webpage of a retail website, the plurality of advertisement requests being for items sold via the retail website, and filter, using a rules engine, the plurality of advertisement requests. The processing device is further configured to acquire, via an application programming interface (API), a plurality of advertisements from at least one third party advertising recommendation platform in response to filtering the plurality of advertisement requests, and fulfill a plurality of available advertisements. The processing device is further configured to mediate the plurality of available advertisements using a weighted reverse index model, the weighted reverse index model configured to be based on at least first data tracking a plurality of relevancy ranks and second data tracking a plurality of bid values, wherein each of the plurality of available advertisements corresponds to one of the plurality of relevancy ranks and one of the plurality of bid values. The processing device is further configured to distribute, via the output device, a predetermined number of selected advertisements to a customer system within a webpage of a retail website in response to mediating the plurality of available advertisements.

In a further aspect, a non-transitory computer-readable storage medium comprising computer-executable instructions is disclosed. The instructions, when executed by a processing device of a computing system, cause the computing system to: receive, via an input device, a plurality of advertisement requests to be placed within a webpage of a retail website, the plurality of advertisement requests being for items sold via the retail website; filter, using a rules engine, the plurality of advertisement requests; acquire, via an application programming interface (API), a plurality of advertisements from at least one advertising platform in response to filtering the plurality of advertisement requests; fulfill a plurality of available advertisements; mediate the plurality of available advertisements using a weighted reverse index model, the weighted reverse index model configured to be based on at least first data tracking a plurality of relevancy ranks and second data tracking a plurality of bid values, wherein each of the plurality of available advertisements corresponds to one of the plurality of relevancy ranks and one of the plurality of bid values; and distribute, via an output device, a predetermined number of selected advertisements to a customer system in response to mediating the plurality of available advertisements for display within a webpage of a retail website.

Other objects and advantages of the invention will be apparent to one of ordinary skill in the art upon reviewing the detailed description of the invention.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic diagram illustrating an example advertising environment in which aspects of the present disclosure may be implemented.

FIG. 2 illustrates an example customer view in a customer system, in accordance with an embodiment.

FIG. 3 illustrates another example customer view in a customer system, in accordance with an embodiment.

FIG. 4 illustrates an example architecture of an advertising system including an advertisement placement manager, in accordance with an example embodiment.

FIG. 5 is a flow chart illustrating an example method for placing advertisements, in accordance with an embodiment.

FIG. 6 is a schematic block diagram illustrating an example advertisement placement engine, in accordance with an embodiment.

FIG. 7 is a schematic block diagram illustrating an example advertisement mediation system, in accordance with an embodiment.

FIG. 8 is a diagram illustrating an example advertisement mediation process, in accordance with an embodiment.

FIGS. 9A-9D are tables illustrating an example advertisement mediation process, in accordance with an embodiment.

FIG. 10 is a flow chart illustrating an example method for mediating advertisements, in accordance with an embodiment.

FIG. 11 illustrates an example computing system on which aspects of the present disclosure may be implemented.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

For purposes of this patent document, the terms “or” and “and” shall mean “and/or” unless stated otherwise or clearly intended otherwise by the context of their use. Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” “including,” “having,” and “has” are interchangeable and not intended to be limiting. The term “such as” also is not intended to be limiting. For example, the term “including” shall mean “including, but not limited to.”

All ranges provided herein include the upper and lower values of the range unless explicitly noted. Although values are disclosed herein when disclosing certain exemplary embodiments, other embodiments within the scope of the pending claims can have values other than the specific values disclosed herein or values that are outside the ranges disclosed herein.

Terms such as “substantially” or “about” when used with values or structural elements provide a tolerance that is ordinarily found during testing and production due to variations and inexact tolerances in factor such as material and equipment.

Generally speaking, the present disclosure relates to systems, methods, and computer products for automatically placing advertisements of products on various retail web pages of a retail website controlled by a retail enterprise, which are to be viewed by customers. In particular, the present disclosure relates to a system architecture that may be interfaced to a plurality of advertisement recommendation systems and/or add partners, performs a ranking and selection of filtered ads, and places ads or other directed content on specific pages of a retail website. Example pages may include, for example, search pages, category or browsing pages, and/or product detail pages.

As disclosed herein, the systems provided mediate directed content to improve customer engagement, for example by placing such directed content corresponding to products that customers tend to want and need. Because the systems and methods described herein improve customer experience and engagement while shopping on retail websites, they can help users reach consumers who already have intent to purchase by nature of searching on retail websites and reach the top of viewing results on retail websites to drive products awareness and consideration.

In an example implementation, a request may be issued in response to a user visiting a page of a retail website on which an advertisement or other directed content may be placed. The request may be translated into an ad request, which is formatted and provided to one or more advertising partners. An ad recommendation may be received in response from the one or more advertising partners. In some examples, multiple recommendations may be received, in an order of priority.

The ad recommendation, or multiple recommendations, may be filtered based on a number of criteria. For example, the systems and methods described herein involve a rules engine responsible of filtering advertisement to control the placement of advertisements and overall experiences for browsing a retail website. In some embodiments, the rules engine blocks all advertisements on certain web pages. In other embodiments, the rules engine blocks particular advertisements associated with specific product identification numbers (e.g., TCINs).

In other example implementations, the systems and methods described herein involve a fulfillment engine responsible of filtering all advertisements acquired from such third party advertisement recommendation platforms based on corresponding product availabilities. For instance, advertisements for out-of-stock items according to inventory data and customer facet data will not be kept after filtering by the fulfillment engine. Additional filters may be applied as well, for example to remove specific products or product identifiers from among those eligible to be advertised on particular webpages within the retail website. Such specific products may be those which are identified as ineligible, or which the user will not purchase.

Once advertisements are filtered, an advertising mediation process may be used to rank and select ads included within the ad recommendations received from third-party advertising recommendation systems. In some instances, a retail enterprise using the systems and methods described herein may deliver, by adopting a weighted reverse index model based on the bid price of an advertisement and its relevancy, a highly engaging and relevant experience for potential customers. The bid price of an advertisement may correspond to a money value that an advertiser has indicated that they are willing to pay to have an advertisement placed. In examples, the weighted reverse index model is adopted without reliance on any inherent bias for the source of any advertisement, e.g., whether the advertisement is associated with a product offered by the enterprise or by a third party.

In other embodiments, the advertisements mediation process includes algorithms, which are internal to the retail website, to use search term relevancy signals to rank and select advertisements. A search term relevancy signal tracks advertisements that are most relevant to search term from the retail website's perspective. In some implementations, the internal algorithm considers customer signals like signed-in behavior of a particular customer, etc.

In further embodiments, the extent to which the mediation process relies on the external recommendations versus the internal relevancy signal may be configurable so that the retail website remains in control of the overall customer experience with respect to advertisements being placed. For example, the mediation engine may give high-performing advertisements more weight while it stops rendering advertisements that can negatively impact customer experience.

Overall, the systems and methods described herein provide improved control by a retail enterprise over the advertisements to be displayed on a retail website of that enterprise. Rather than relying solely on third-party ad recommendations, and optionally filtering those ad recommendations based on whether products are sold by the enterprise, the present systems and methods allow for other types of filtering, sorting, and prioritization based on individual locations within the retail website, product availability, source, and various other factors that would otherwise not be known to the third-party ad recommendation system, overall improving the control flexibility of the retail enterprise.

In example applications, a retail enterprise may use such an advertisement placement management system to select and place promoted product content within locations in a retail webpage in a highly customized manner. For example, a retail enterprise offering products from a variety of manufacturers may offer to those manufacturers an opportunity to promote specific products within a retail user interface, such as search results or a product category page, e.g., in line with other search results or product listings. As such, the retail enterprise may obtain the benefit of offering advertising services to those manufacturers, while promoting products to customers that are sold by that retail enterprise and which are readily available to be provided to that customer.

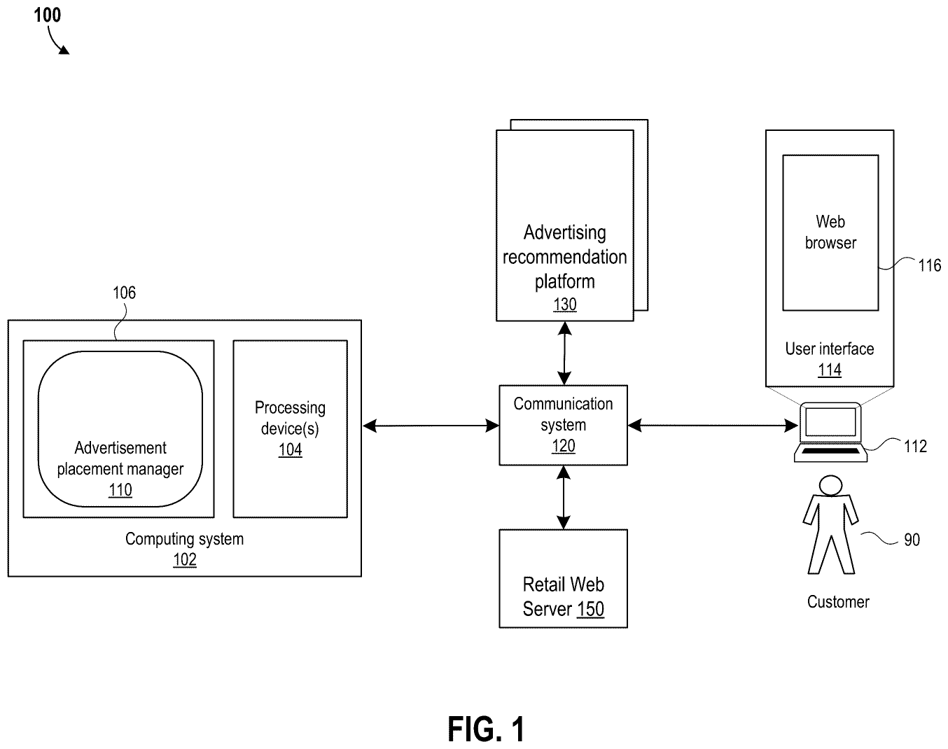

Referring first to FIG. 1, an example advertising environment 100 in which aspects of the present disclosure may be implemented is shown. The example advertising environment 100 includes a computing system 102 on which the advertisement control processes described herein may be implemented, as well as a customer system 112, a communication system 120, one or more advertising platforms 130, and a retail web server 150. A customer 90 is also shown in FIG. 1. The computing system 102, the customer system 112, the advertising recommendation platform 130, and the retail website 150 are configured to communicate with each other by sending and receiving signals via the communication system 120.

In this context, the customer system 112 is configured to render webpages (e.g., webpages of retail websites) that are viewed by the customer 90 when the customer 90 operates the customer system 112. The customer system 112 may interact with the retail website 150 (e.g., which may be implemented on a web server system) using a browser 116 or mobile application displayable at a user interface 114 of the customer device 112. The customer 90 may may visit various pages provided by the retail website, such as a search page, a category page, or a product detail page. Each page presented to the customer 90 at the customer system 112 may have varying levels of specificity as to the products displayed.

The computing system 102 is configured to receive advertisement requests, via the communication system 120, from the retail web server 150 in response to, and in conjunction with, delivery of webpages to the customer system 112 for display. As discussed further below, the computing system 102 may include one or more processing devices 104 and a memory 106 which stores instructions for implementing an advertisement placement manager 110. The advertisement placement manager 110, when executed, receives advertisement requests from the retail web server 150, routes advertisement requests to one or more advertising platforms 130, and performs various selection processes to determine the one or more advertisements or other directed content to be displayed to the customer 90 in the retail website when rendered within web browser 116 at the customer system 112.

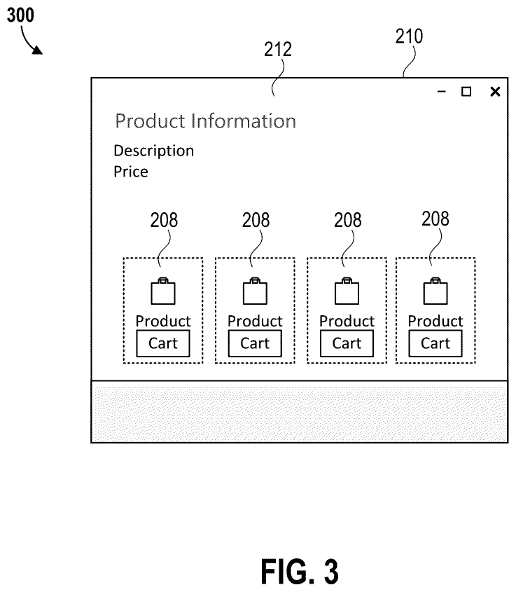

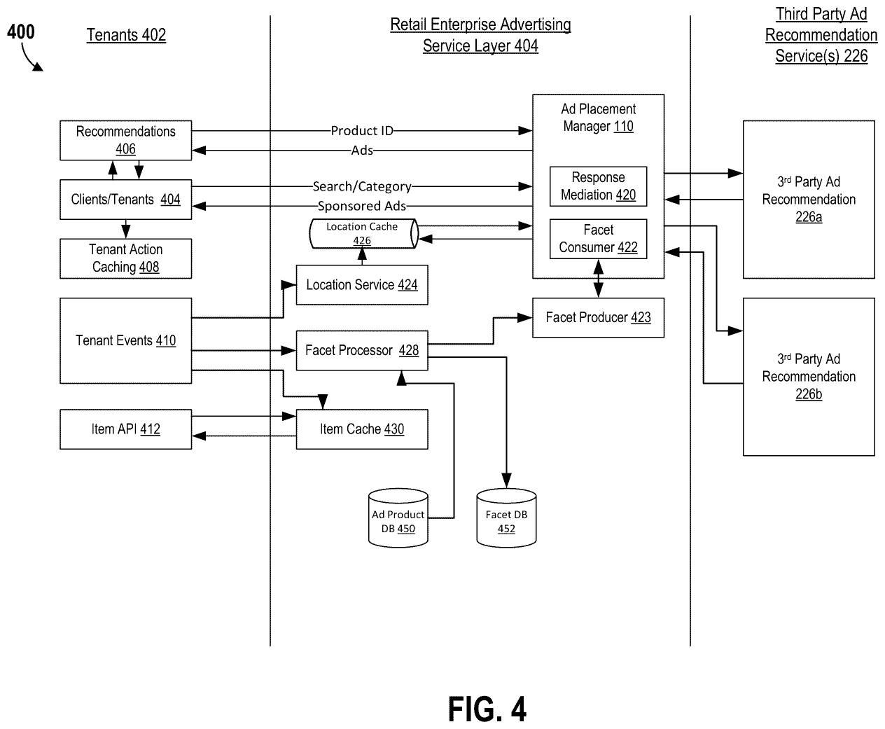

When instructions for the advertisement placement manager 110 are executed by the processing device 104, the processing device 104 is configured to process advertisement recommendations received from the one or more advertising recommendation platforms 130, and place at least a portion of the processed advertisements, via the communication system 120, to the customer system 112 in conjunction with display of a page of a retail website. Details about the advertisement placement manager 110 are described in connection with FIG. 3 and FIG. 4.

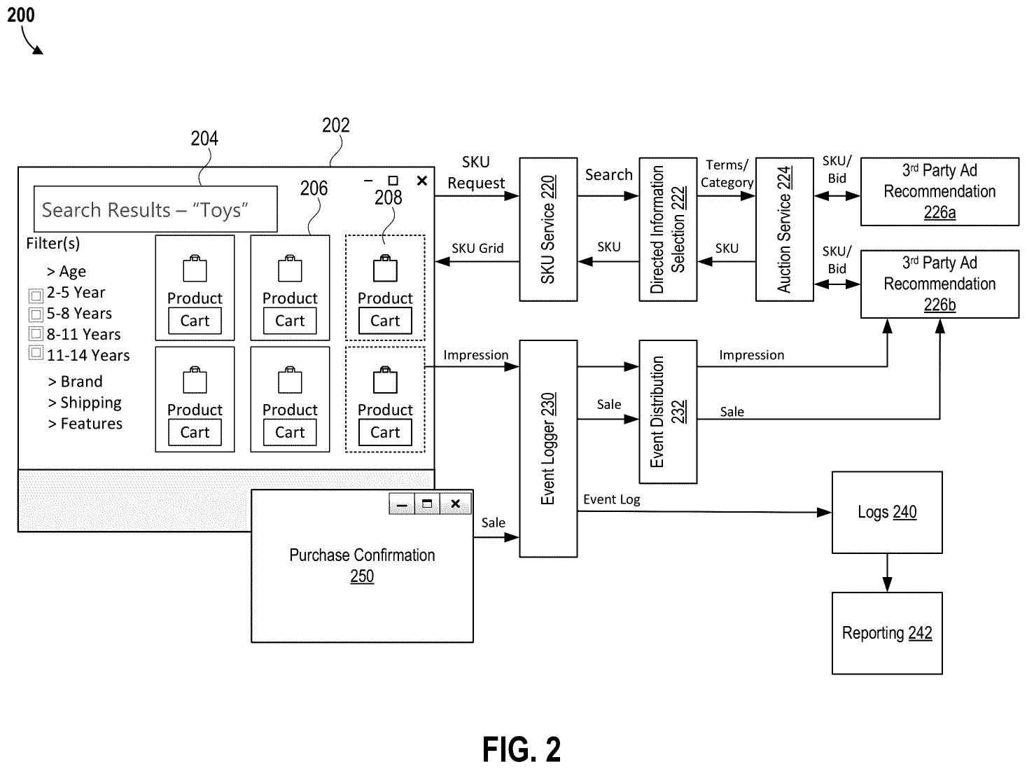

In some embodiments, the customer system 112 includes a user interface 114. The user interface 114 is configured to receive inputs from the customer 90 into the customer system 112. The user interface 114 is also configured to render outputs (for example, webpages) to be viewed by the customer 90. The user interface 114 includes a web browser 116. The web browser 116 is configured to render webpages such as those of retail websites to be viewed by the customer 90. When the computing system 102 places the processed advertisements, via the communication system 120, to the customer system 112, webpages rendered by the web browser 116 display the advertisements placed by the computing system 102. Details about the rendered webpages are described in connection with FIG. 2A and FIG. 2B.

In some embodiments, the one or more advertising recommendation platforms 130 are configured to auction advertisements that can be supplied to advertisers to promote their products and brands. Advertisers can bid prices for advertisements supplied on an advertising recommendation platforms 130. In some implementations, bids from advertisers are measured by cost per click, which is the value an advertiser must pay for each customer click of an advertisement on a retail website. In some implementations, an advertising recommendation platform 130 supports manual bidding strategies to allow for setting the true cost-per-click value that an advertiser would like to bid at. An advertiser can place bids on individual keywords within a campaign based on targeting strategy. In other implementations, the advertising recommendation platform 130 allows an advertiser to choose between manual and automated bidding strategies. In further implementations, an advertiser can choose the keywords they want to bid on by a product identification number and set the bid price based on targeting strategy. The advertising recommendation platforms 130 may also support manual validation on all keywords before the advertising campaign is initiated. In yet further implementations, the advertising recommendation platforms 130 adopt a keyword discovery model that automatically associates search queries with a relevant set of product identification numbers. As a result, advertisement recommendations will be provided that are associated with a maximum number of terms of search queries, including misspelled keywords.

In some embodiments, the communication system 120 includes a set of computing devices and links between the computing devices. The computing devices in the communication system 120 use the links to enable communication among multiple computing devices and systems that are connected to the communication system 120. The communication system 120 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices. In some example implementations, the communication system 120 may include the Internet. The communication system 120 may also include one or more enterprise network systems, for example for communication between the retail web server 150 and computing system 102 hosting the advertisement placement manager 110.

FIG. 2A illustrates an example webpage 200 rendered by web browser 116 of the customer system 112, to be viewed by the customer, as well as a messaging flow resulting in delivery of particular directed content, such as advertisements, on the webpage. In the example shown, the webpage 200 may be rendered in a window 202, and includes a search field 204, at least one result product view 206, and one or more directed information fields 208. Webpages on which product advertisements are placed by the computing system 102 can be search pages, category/browse pages, and product detail pages. The example webpage 200 can be a search page or category/browse page. An advertiser can bid for an eligible product to be boosted as an advertisement for the eligible product is placed beyond organic ranking into the available sponsored slots (for example, the directed information fields 208) of the search page or category/browse page.

In the example shown, a set of predefined positions may be used and populated as directed information fields 208, while other similarly-situated fields, e.g., the result product views 206, are presented in analogous locations. In the example shown, the webpack 200 includes a set of filters in addition to the search field 204 to narrow results from a search.

When the computing system 102 (illustrated and described in FIG. 1) renders the webpage 200 in response to a search or category browse operation, a SKU request may be transmitted to a SKU service 220. The SKU service 220 may lookup a set of product SKUs that correspond to products responsive to the search or category browse operation, and which will be displayed within the result product views 206. The SKU service 220 may forward a search request to a directed information selection system 222. The directed information selection service 222 may generate, from the search parameters received via the SKU service 220, a set of one or more terms relevant to an advertisement to be placed, or a category corresponding to the category displayed in the webpage 200. The search terms or category may be passed to an auction service 224.

In the example shown, the auction service 224 is interfaced to a plurality of third-party ad recommendation services, shown as services 226a-b. Although two such services are shown, in alternative embodiments more than two services may be used. The auction service 224 may submit the term or category information to one or more of the third-party ad recommendation services 226a-b. Each responding service may provide a particular bid as managed by the auction service, as well as an identifier (e.g., a SKU) identifying an item for placement within the webpage 200. Details regarding an example auction managed by the auction service 224 are described further below. Generally speaking, a winner of the auction may correspond to one or more SKUs, which are then returned from the auction service 224 to the directed information selection service 222, which returns those SKUs to the SKU service 220. The SKU service 220 returns and SKU grid for rendering on the webpage 200. The SKU grid may include, for example, both results product views 206 and one or more products identified by the directed information selection service 222 (e.g., as a result of the auction presented to third-party ad recommendation services 226a-b) within directed information fields 208.

In the example shown, once the result product views 206 and directed information fields 208 are displayed, a user may select one or more such items, for example to view additional information about the item (e.g., in an item detail page), or may select to add that item to a shopping cart. Such interaction with an item may results in an impression being tracked within the webpage 200, and provided to an event logger 230. In the example shown, an impression is generated in response to selection of an item presented within a directed information field 208.

The event logger 230 may transmit feedback to an event distribution service 232, as well as to event logs 240. In the example shown, in which the impression is generated from selection of a directed information field 208, the event distribution service 232 may forward event activity, such as an impression, to the particular third-party ad recommendation service that provided the SKU associated with the winning bid managed by the auction service 224. Similarly, in the event of a purchase (placement of an item in a cart and customer completion of a check out operation associated with that cart) a purchase confirmation 250 may result in transmitting a sale event to the event logger 230 which may forward the sale event to the event distribution service 232 which may also provide feedback to the associated third-party ad recommendation service 226. Additionally, the event logger 230 may generate an event log of impressions and/or sales, which are provided to log storage 240 for purposes of generating reporting 242. Such reporting may indicate, for example, instances of or rates of selection of items displayed within the directed information fields 208 relative to items displayed within results product views 206. Other information may be included within such reporting as well.

In examples, the directed information selection service 222 may be incorporated within the advertisement placement manager 110. In further examples, the advertisement placement manager 110 may include the directed information selection service 222, as well as the auction service 224. The SKU service 220, event logger 230, and event distribution service 232 may be maintained within a retail web server, such as a retail web server 150 of FIG. 1.

Referring now to FIG. 3, a further webpage 300 reflecting a product detail view 212 is shown. The product detail view 212 may be displayed in response to selection of a particular product, whether a result of a search, or a result of selection of a directed information field 208 as described above. In the example shown, the product detail view 212 may include a description of the product a price of the product, as well as one or more images or product reviews associated with that product. The webpage 300 may include one or more directed information fields 208 that may be of interest to a consumer viewing the webpage 300. A sequence of messages analogous to that seen above in FIG. 2 may be utilized to generate an auction process and return one or more SKUs for presentation within the directed information fields 208. In example implementations, each directed information field 208 may be auctioned independently, with particular fields having different values (e.g., central fields having a greater value, and potentially being auctioned at a different value as compared to fields along an edge of the webpage 300).

Referring to FIG. 4, a detailed architecture diagram 400 is shown that may be used to implement portions of the system described above in conjunction with FIGS. 1-3. In the example shown, the architecture diagram 400 includes tenants 402, a retail enterprise advertising service layer 404, and third-party ad recommendation services 226.

In the example shown, the tenants 402 include a plurality of services that may cooperate, and may be implemented at a web server (e.g., retail web server 150) to deliver to a customer a retail website. may correspond to customer browsing sessions on a retail website, with each tenant corresponding to a system (e.g., a customer system or a server hosting the retail website) that generates search, browse, or purchase events. In the example shown, a set of discrete tenants 404 each may issue search or category messages to an advertisement placement manager 110 within the enterprise advertising service layer 404, and receipt of directed information, for example in the form of sponsored advertisements. Additionally, each discrete tenant 404 may interface with a recommendations system 406 which responds with specific recommended directed content in response to a particular product identifier. The recommendations system may submit a product identifier to the advertisement placement manager 110, and may receive in response identifiers of other items within an enterprise item collection to be advertised or recommended to an end user in response. The recommendations system the 406 may then return those items to be advertised to the respective tenant 404. A tenant action caching service 408 receives actions taken by customers with respect to any given tenant, for example selection of a product, purchase of the product, and the like.

A tenant events service 410 receives specific events taken or received at the tenants, which may include, for example, an indication of a customer location, a particular facet (e.g. a product category), or a particular item. The tenant events service 410 may route such events to a location service 424, a facet processor 428, or an item cache 430, each maintained within the enterprise advertising service layer 404. An item API 412 may submit item IDs (e.g., SKUs) to the item cache 430, and receive in response item data, for example for display to a user.

In the example shown, the location service 424 will determine a location associated with a particular tenant event (e.g., a location of customer 90), and provide the location to location cache 426. The location is made available to the p advertisement placement manager 110, for example for localization of particular product ads. Similarly, facets received as part of one or more tenant events 410 at the facet processor 428 may be routed to a facet database 452, as well as to a facet producer 423. Facets may include, for example, product categories or subcategories, filters applied to a product category, individual product pages, and other types of views of products that may be presented within a retail webpage in which directed information, such as advertisements, may be displayed. The facet producer 423 may provide the facet to the advertisement placement manager 110, in particular to the facet consumer 422 positioned therein.

In the example shown, the advertisement placement manager 110 includes a response mediation service 420 and the facet consumer 422. The response mediation service 420 receives requests, for example from tenants 404 and recommendation service 406, and submits requests to one or more third-party ad recommendation services 226a-b. The response mediation service 420 receives responses from the third-party ad recommendation services 226a-b, and controls the responsive ad information sent back to tenants 404 or recommendations service 406 based on, for example, auction outcomes, enterprise priorities, and the like. The facet consumer 422 receives facet information from facet producer 423, which provides additional contextual information that may be submitted to the one or more third-party ad recommendation services 226, for example in conjunction with location information and to specific product identifiers or categories.

Referring to FIGS. 1-4 generally, in example use cases, a customer 90 may input a search term into a search field 204. In response to the search term, a retail Web server 150 may generate a webpage for display within a web browser 116 of customer system 112 that includes at least one results product view 206. The retail web server 150 may relay information associated with the search term or items displayed in the results product view 206 computing system 102, and in particular to advertisement placement manager 110. This related information may include one or more SKUs (e.g. as generated at SKU service 220 of FIG. 2). In other implementations, the advertisement placement manager passes the search terms without SKUs, and third party advertisement recommendation services 226a-b identify SKUs to be associated with advertisements. Based on various context information, including the search term or category selected by the customer 90, a customer location, and specific customer selections, context information may be passed, e.g., via directed information selection service 222, to auction service 224, which mediates among third party advertisement recommendation services 226a-b to conduct an auction process for a particular item placement, as detailed below. The auction process may then result in a particular price per impression (click or sale, for example), as well as specific directed information placements (e.g., ads) for placement within a webpage alongside requested content (e.g., the specific SKUs to be placed by a third party advertisement recommendation service). Alternatively, the placements may be on a product detail page, as illustrated in FIG. 3. In further versions, placements may be on other types of pages that might be displayed within a retail website, such as product listing pages, product display pages, and recommendation carousels as presented within a browser and/or within mobile applications supported by various mobile operating systems.

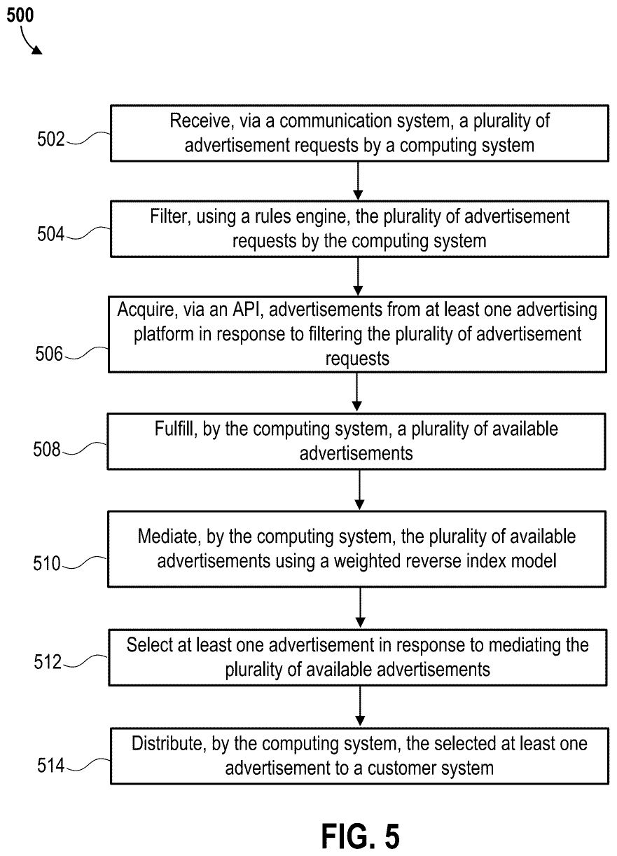

Referring to FIG. 5, a flow chart is shown to illustrate an example method 500 for placing advertisements of advertised products. In some examples, the example method 500 is operated by the computing system 102 (illustrated and described in FIG. 1). In the illustrated example, the method 500 includes steps 502, 504, 506, 508, 510, 512, and 514.

In the example shown, the method 500 includes receiving, via a communication system (e.g., communication system 120), a plurality of advertisement requests by a computing system (step 502). In some embodiments, the advertisement requests are generated in response to activities of the customer 90 in relation to using the web browser 116 of the customer system 112, interactively with retail web server 150, and the requests may be generated by subsystems at the retail web server. The advertisement requests are configured to correspond to factors including customer query, customer facets, platforms, store information, etc. For instance, when the advertisement requests are set to track customer query, search term, product category, individual product identification number, and/or a set of multiple product identification numbers may be considered independently or in various combinations. Various types of customer facets including regular facets, location facets, and custom price values can contribute to the generation of advertisement requests. Regarding platform, the advertisement requests may differentiate between whether the customer system 112 is operated in a mobile application or on a desktop system.

The method 500 further includes filtering, using a rules engine, the plurality of advertisement requests by the computing system (step 504). The filtering by the rules engine is configured to control what types of advertisements cannot be placed to the customer system 112. In some implementations, the rules engine blocks all advertisements on certain web pages. In other implementations, the rules engine blocks particular advertisements having specific advertisement identification numbers (e.g., TCINs, or SKUs). In various examples, rules of the rules engine can be applied at webpage type level, platform level, certain data range, source of advertisements, and/or according to rule criteria like search terms, categories, product identification numbers, and customer facets. Multiple ways of applying the rules of the rules engine can be implemented either independently or in various combinations. In some embodiments, the filtering by the rules engine is configured to filter out certain advertisements sent by the advertising recommendation platform 130, the certain advertisements corresponding to filtered advertisement requests. The filtering is configured to occur after all advertisement requests are sent to an advertising recommendation platform 130, to obtain recommended directed content for display to customer 90. In other embodiments, the filtering by the rules engine is configured to block certain advertisement requests sent to the advertising recommendation platform 130. The filtering, in that instance, is configured to occur before all advertisement requests are sent to the advertising recommendation platform 130.

The method 500 further includes acquiring, via an application programming interface (API), advertisements from at least one advertising platform in response to filtering the plurality of advertisement requests (step 506) and fulfilling, by the computing system, a plurality of available advertisements (step 508). In some embodiments, the process of fulfilling available advertisements involves removing advertisements that are not available at a location based on, e.g., inventory data and location facets. Depending on the delivery option that the customer 90 selects, by inputting into the web browser 116 of the customer system 112, including order pickup, same-day delivery, in-store, or shipping, the process of fulfilling determines whether an advertisement corresponds to a product that is available based on options chosen by the customer 90. For instance, advertisements for out-of-stock products according to inventory data and customer facet will not be maintained for display after fulfillment filtering.

The method 500 further includes mediating, by the computing system, the plurality of available advertisements using a weighted reverse index model (step 510) and selecting at least one advertisement in response to mediating the plurality of available advertisements (step 512). The process of mediating available advertisements is configured to choose advertisements that are to be placed by the computing system 102 to the customer system 112, e.g., within a webpage generated at retail web server 150. In some examples, there are more advertisements returned from the advertising recommendation platform(s) 130 than slots available for displaying advertised products on webpages rendered by the web browser 116 of the customer system 112. In other examples, multiple advertising recommendation platforms respond to an advertisement request by providing advertisements for the same advertised product. In further examples, there is need to identify more relevant advertisements from the plurality of available advertisements. The goals of mediating available advertisements include delivering relevant advertisements, maximizing commercial return on bids for advertisements, and building no inherent bias for any particular advertising platform.

In some embodiments, the weighted reverse index model is based on at least first data tracking a plurality of relevancy ranks and second data tracking a plurality of bid values, wherein each of the plurality of available advertisements corresponds to one of the plurality of relevancy ranks and one of the plurality of bid values. The weighted reverse index model relies on the relevancy and the bid value determined by the one or more advertising recommendation platforms 130.

In other embodiments, the weighted reverse index model may be adjusted by algorithms, which are internal to the retail website (e.g., generated and/or maintained at retail web server 150), to use search term relevancy signals to rank and select advertisements. A search term relevancy signal tracks advertisements that are most relevant to search term from the retail website's perspective. In some implementations, the internal algorithm considers customer signals like signed-in behavior of a particular customer, etc.

In further embodiments, the process of mediating available advertisements includes backfilling vacant slots available for displaying advertised products on webpages rendered by the web browser 116 of the customer system 112, by filling in a new advertising platform based on relevancy of advertisements.

The method 500 further includes distributing, by the computing system, the selected at least one advertisement to a customer system (step 514). In some embodiments, the customer system 112 receives the distributed advertisements and displays them while rendering webpages by the web browser 116 (illustrated and described in FIGS. 1-3).

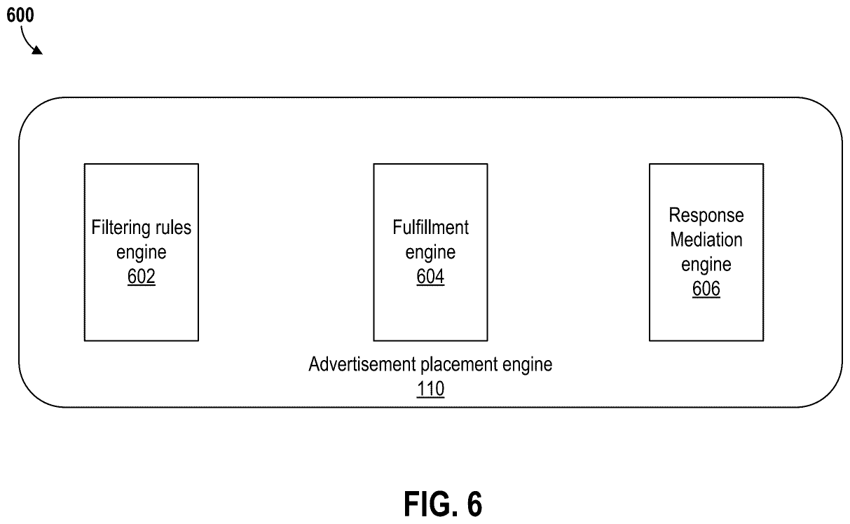

FIG. 6 illustrates an example schematic diagram 600 which shows building blocks of the advertisement placement manager 110, in accordance with an embodiment. In the illustrated example, the advertisement placement manager 110 includes a filtering rules engine 602, a fulfillment engine 604, and a mediation engine 606. In some implementations, the filtering rules engine 602 is configured to filter the plurality of advertisement requests. The step 504 of the example method 300 (illustrated and described in FIG. 3) may, in some instances, be operated by the filtering rules engine 602. In other implementations, the fulfillment engine 604 is configured to fulfill a plurality of available advertisements by filtering out certain advertisements based on availability and/or eligibility. The step 508 of the example method 500 (illustrated and described in FIG. 5) is operated by the fulfillment engine 604. In further implementations, the mediation engine 606 is configured to mediate the plurality of available advertisements using a weighted reverse index model. The step 310 of the example method 300 (illustrated and described in FIG. 3) is operated by the mediation engine 606. In examples, mediation engine 606 may correspond to response mediation service 420 of FIG. 4.

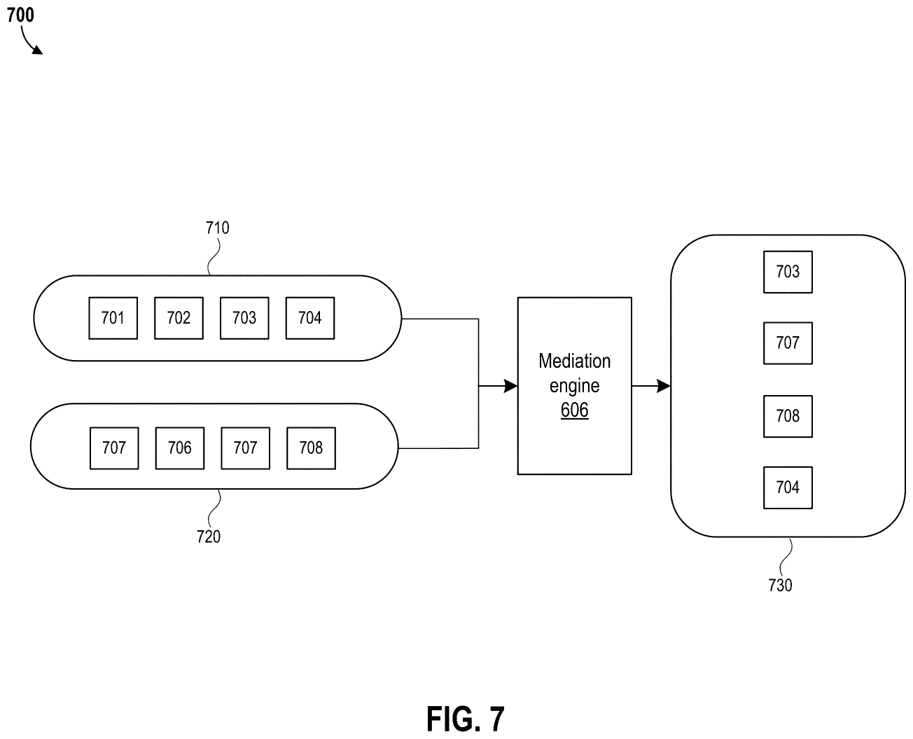

FIG. 7 illustrates an example advertisement mediation system 700 using the mediation engine 606. Besides the mediation engine 606, the example advertisement mediation system 700 includes a first available advertisements pool 710, a second available advertisements pool 720, and a selected advertisements pool 730.

In some embodiments, the first available advertisements pool 710 is generated by the fulfillment engine 604 of the advertisement placement manager 110 (illustrated and described in FIG. 6) by processing advertisements sent from a first third party advertising recommendation service. The second available advertisements pool 720 is generated by the fulfillment engine 604 of the advertisement placement manager 110 by processing advertisements sent from a second third party advertising recommendation service. The first available advertisements pool 710 includes available advertisements 701, 702, 703, and 704. The second available advertisements pool 720 includes available advertisements 705, 706, 707, and 708. After processing by the mediation engine 606, the selected advertisements pool 730 is generated. The selected advertisements pool 730 includes four selected advertisements 703, 705, 708, and 704. The four selected advertisements are ranked by the mediation engine 606, based on the weighted reverse index model, in a descending order. The selected advertisement 703 corresponds to a highest score according to the weighted reverse index model. In some implementations, the number of slots available for displaying advertised products on webpages rendered by the web browser 116 of the customer system 112 equals to the number of the selected advertisements in the selected advertisements pool 730. In other implementations, the number of slots available for displaying advertised products on webpages rendered by the web browser 116 of the customer system 112 is greater than the number of the selected advertisements in the selected advertisements pool 730. The number of slots available for displaying advertised products may be based, for example, on an intended layout of the webpage on which the advertised products will be displayed, examples of which are seen in FIGS. 2-3.

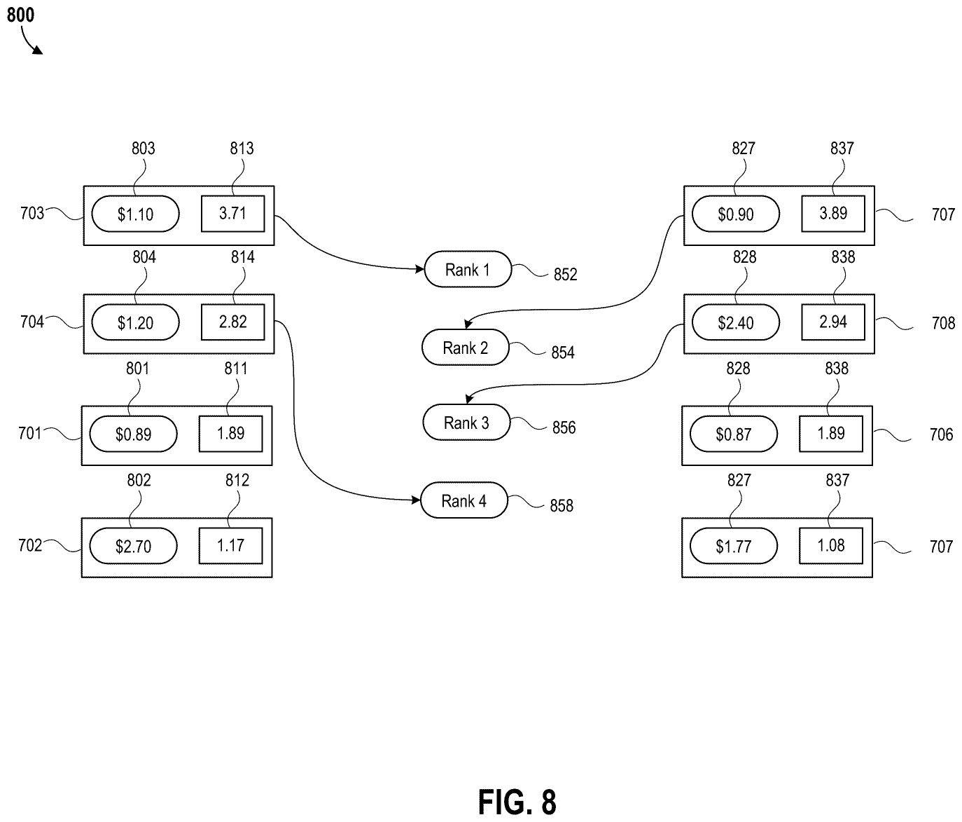

FIG. 8 illustrates an example advertisement mediation process 800. In the illustrated example, the available advertisements 701, 702, 703, and 704 from the first third party advertising recommendation service are shown. Also, the available advertisements 705, 706, 707, and 708 from the second third party advertising recommendation service are shown. Further, a first rank slot 852, a second rank slot 854, a third rank slot 856, and a fourth rank slot 858 are shown.

In some embodiments, each of the available advertisements 701, 702, 703, 704, 705, 706, 707, and 708 includes a bid value. The included bid values are, respectively, 801, 802, 803, 804, 825, 826, 827, and 828. Each of the available advertisements 701, 702, 703, 704, 705, 706, 707, and 708 also includes a weighted score calculated based on the weighted reverse index model. The included weighted scores are, respectively, 811, 812, 813, 814, 835, 836, 837, and 838. According to the respective weighted scores, the available advertisement 703 is placed into the first rank slot 852; the available advertisement 705 is placed into the second rank slot 854; the available advertisement 708 is placed into the third rank slot 856; the available advertisement 704 is placed into the fourth rank slot 858.

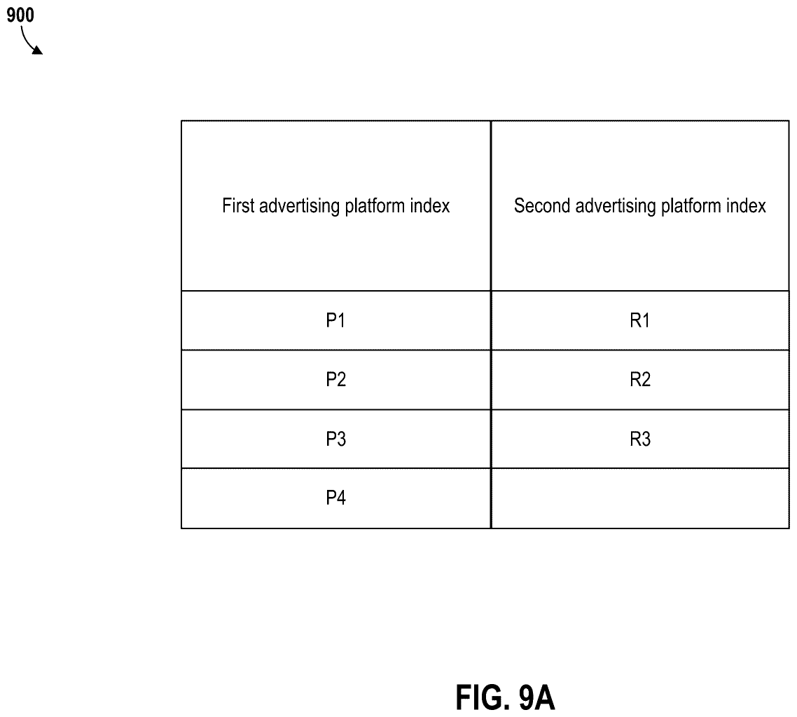

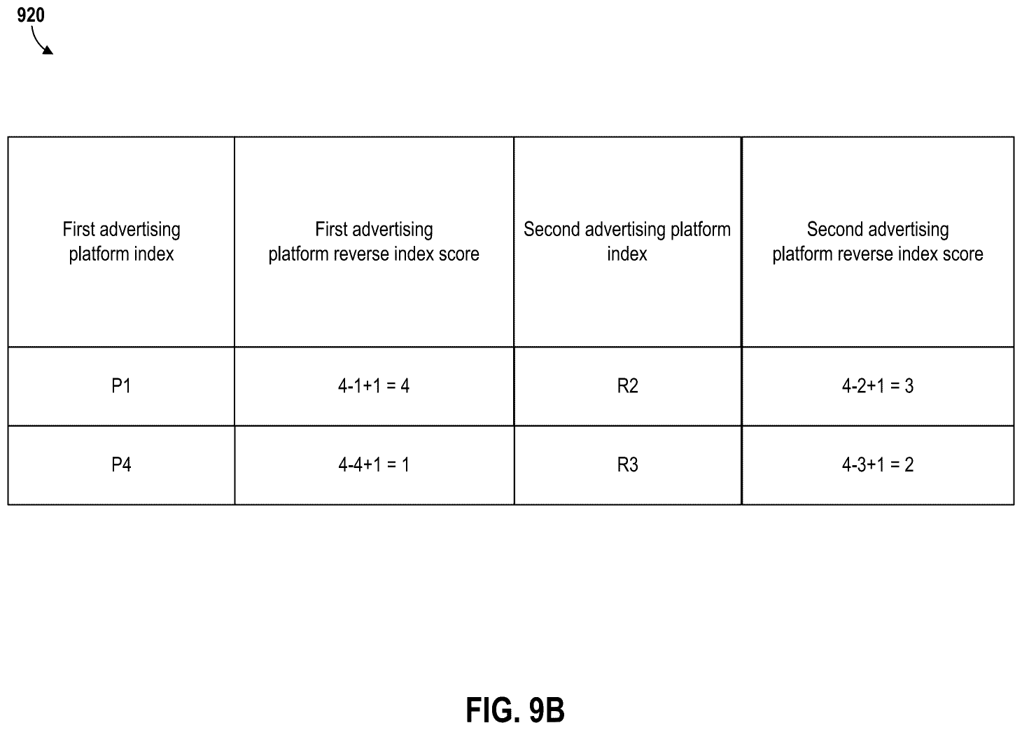

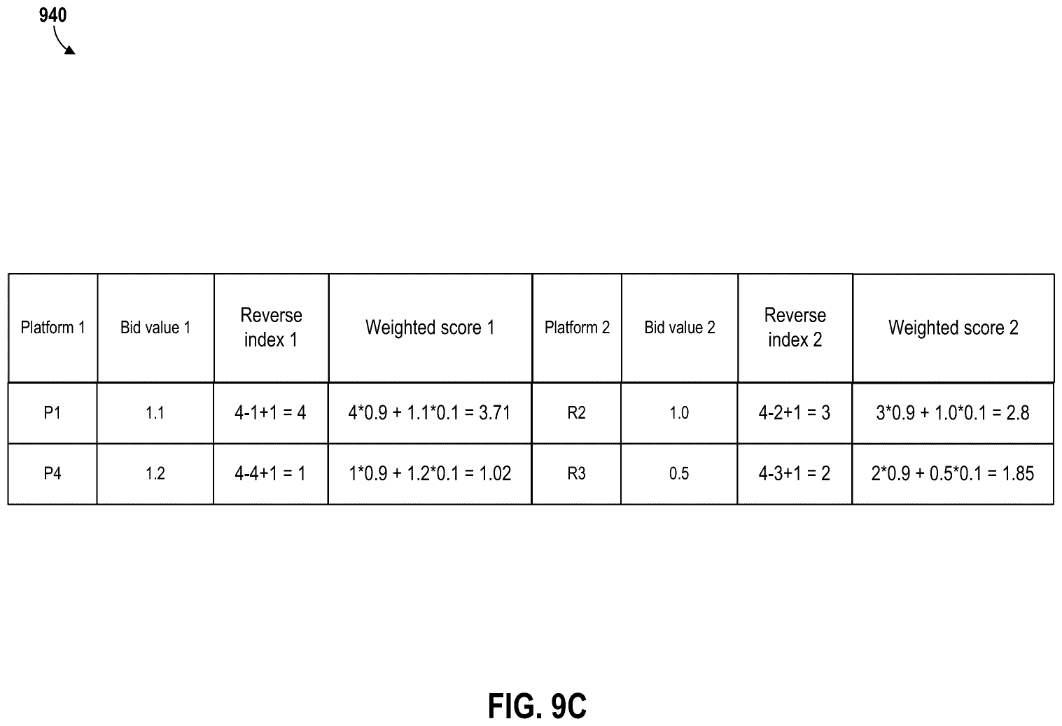

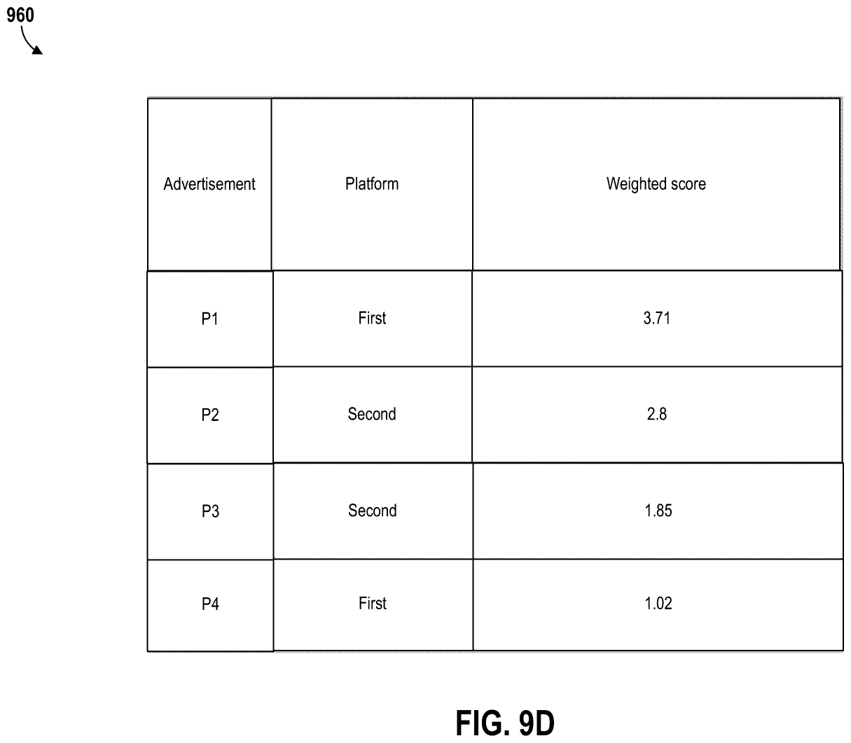

FIG. 9A is an example table 900 illustrating a first intermediate result of an example advertisement mediation process. In this illustrated example, a first column of the example table 900 shows a index and a second column of the example table 900 shows a second index. The first index includes advertisements P1, P2, P3, and P4. The advertisements P1, P2, P3, and P4 are ranked in a descending order based on relevancy in relation to an advertisement request, as determined by an advertising platform (for example, a third party advertising recommendation service implemented by an advertising recommendation platform 130). The advertisement P1, as shown, is relatively the most relevant one. The advertisement P4 is relatively the least relevant one. The second index includes advertisements R1, R2, and R3. The advertisements R1, R2, and R3 are ranked in a descending order based on relevancy in relation to the advertisement request, as determined by another third party advertising recommendation service implemented at a different advertising recommendation platform 130. Among the advertisements recommended within the second index, advertisement R1 is relatively the most relevant one. The advertisement R3 is relatively the least relevant one.

FIG. 9B is an example table 920 illustrating a second intermediate result of the example advertisement mediation process. In this illustrated example, a first column of the example table 920 shows the first advertising platform index after a fulfillment process (for example, the step 508 of the example method 500). A second column of the example table 920 shows a first advertising platform reverse index score for each of the remaining advertisement in the first column. A third column of the example table 920 shows the second advertising platform index after the fulfillment process (for example, the step 508 of the example method 500). A fourth column of the example table 920 shows a second advertising platform reverse index score for each of the remaining advertisement in the third column.

In some embodiments, an index field value to an advertisement is assigned to indicate the natural relevancy order (for example, the first or the second column of the example table 900) as determined by the advertising platform from which the advertisement is sent, the index field value starting from 1 for the most relevant advertisement. In some implementations, index field values are assigned prior to the fulfillment process. In other implementations, index field values are assigned after the fulfillment process.

In some embodiments, a total count of advertisements is determined by finding the number of advertisements sent by whichever advertising platform that sends the most advertisements to the computing system 102. For instance, as shown by the example table 900, a first advertising platform sends four advertisements, and a second advertising platform sends three advertisements. Hence, the total count of advertisements is determined as four.

Based on the total count of advertisements and the index field value of each advertisement, a reverse index score of each advertisement is computed as the total count of advertisements minus the index field value, then plus one. For instance, the reverse index score of the advertisement P1 is 4 and the reverse index score of the advertisement P4 is 1. The reverse index score of the advertisement R2 is 3 and the reverse index score of the advertisement R3 is 2.

FIG. 9C is an example table 940 illustrating a third intermediate result of the example advertisement mediation process. In this illustrated example, a first column, a third column, a fifth column, and a seventh column of the example table 940 shows, respectively, the first index after a fulfillment process, the first reverse index scores, the second index after the fulfillment process, and the second reverse index scores (illustrated and described in FIG. 9B). In addition, a second column of the example table 940 shows a bid value of each of the remaining advertisement in the first column, the bid value indicating a price that an advertiser is willing to pay for placing the advertisement on the customer system 112. Likewise, a sixth column of the example table 940 shows a bid value of each of the remaining advertisement in the fifth column. A fourth column of the example table 940 shows a weighted score for each of the remaining advertisement in the first column, based on the corresponding index field value and bid value. Similarly, an eighth column of the example table 940 shows a weighted score for each of the remaining advertisement in the fifth column.

In some embodiments, an index weight and a bid weight are assigned for the mediation engine 406 (illustrated and described in FIG. 4) across all advertising platforms. A weighted score for an advertisement is computed as the sum of: (1) the corresponding reverse index score times the index weight; and (2) the corresponding bid value times the bid weight. For instance, the weighted score for the advertisement P1 is 3.71. The weighted score for the advertisement P4 is 1.02. The weighted score for the advertisement R2 is 2.8. The weighted score for the advertisement R3 is 1.85.

FIG. 9D is an example table 960 illustrating a final result of the example advertisement mediation process. In this illustrated example, advertisements P1, R2, R3, and P4 are ranked by their respective weighted scores in a descending order. The first ranked advertisement P1 has the highest weighted scores. Hence, the advertisement P1 will be the first to be distributed to the customer system 112 (for example, the step 314 of the example method 300).

In some embodiments, when two recommended advertisements have the same weighted score, the advertisement with a lower index field value, which indicates higher reverse index score thus higher relevancy, is ranked higher.

In other embodiments, when a first advertisement identification number of a first available advertisement equals to a second advertisement identification number of a second available advertisement, whichever available advertisement with the lower weighted score is removed from the selected advertisement pool 730.

In further embodiments, when a floor bid value is received by the mediation engine 406 from a bid value system, any available advertisement with a bid value that is lower than the floor bid value is removed from the selected advertisement pool 730.

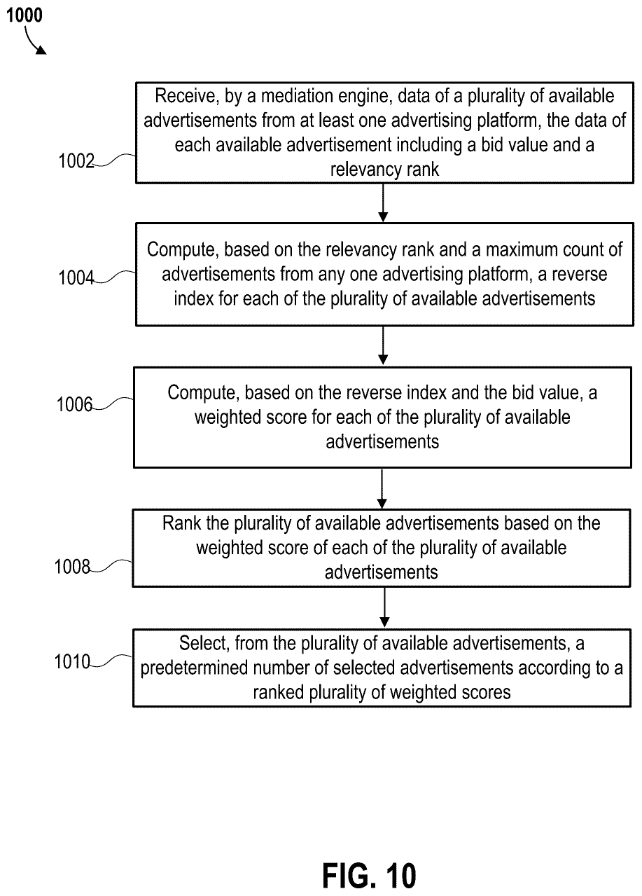

Referring to FIG. 10, a flow chart is shown to illustrate an example method 1000 for mediating advertisements. In some examples, the example method 1000 is operated by the mediation engine 606 (illustrated and described in FIG. 6, for example implemented within response mediation service 420 of FIG. 4). In the illustrated example, the method 1000 includes steps 1002, 1004, 1006, 1008, and 1010.

In the example shown, the method 1000 includes receiving, by a mediation engine, data of a plurality of available advertisements from at least one third party advertising recommendation platform, the data of each available advertisement including a bid value and a relevancy rank (step 1002). In some embodiments, the relevancy rank is based on external recommendations from advertisement platforms. The method 1000 further includes computing, based on the relevancy rank and a maximum count of advertisements from any one advertising recommendation platform, a reverse index for each of the plurality of available advertisements (step 1004). In some implementations, relevancy ranks are determined prior to the fulfillment process. In other implementations, relevancy ranks are determined after the fulfillment process.

The method 1000 further includes computing, based on the reverse index and the bid value, a weighted score for each of the plurality of available advertisements (step 1006). The weighted score is configured to balance the relevancy of any advertisement to be placed to the customer system 112 and the commercial value of the corresponding advertisement to the retail website.

In addition, the method 1000 includes ranking the plurality of available advertisements based on the weighted score of each of the plurality of available advertisements (step 1008) and selecting, from the plurality of available advertisements, a predetermined number of selected advertisements according to a ranked plurality of weighted scores (step 1010).

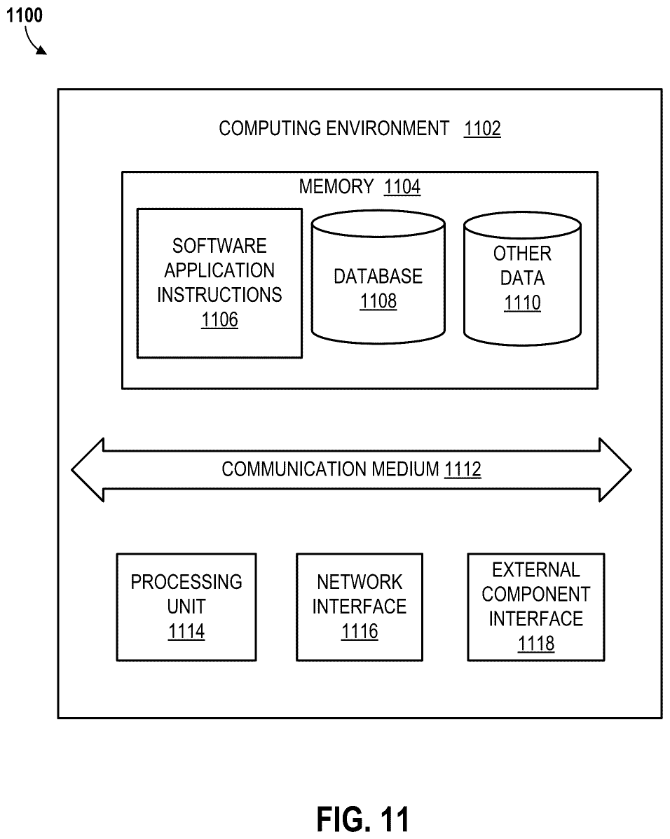

FIG. 11 illustrates an example system 1100 with which disclosed systems and methods can be used. In an example, one or more such systems 1100 may be used to implement the computing system, the customer system, the communication system, and/or the advertising platform described above in conjunction with FIG. 1, within an advertising environment such as is seen in FIG. 1.

In an example, the system 1100 can include a computing environment 1102. The computing environment 1102 can be a physical computing environment, a virtualized computing environment, or a combination thereof. The computing environment 1102 can include memory 1104, a communication medium 1112, one or more processing units 1114, a network interface 1116, and an external component interface 1118.

The memory 1104 can include a computer readable storage medium. The computer storage medium can be a device or article of manufacture that stores data and/or computer-executable instructions. The memory 1104 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 1104 can store various types of data and software. For example, as illustrated, the memory 1104 includes software application instructions 1106, one or more databases 1108, as well as other data 1110.

The communication medium 1112 can facilitate communication among the components of the computing environment 1102. In an example, the communication medium 1112 can facilitate communication among the memory 1104, the one or more processing units 1114, the network interface 1116, and the external component interface 1118. The communications medium 1112 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 1114 can include physical or virtual units that selectively execute software instructions, such as the software application instructions 1106. In an example, the one or more processing units 1114 can be physical products comprising one or more integrated circuits. The one or more processing units 1114 can be implemented as one or more processing cores. In another example, one or more processing units 1114 are implemented as one or more separate microprocessors. In yet another example embodiment, the one or more processing units 1114 can include an application-specific integrated circuit (ASIC) that provides specific functionality. In yet another example, the one or more processing units 1114 provide specific functionality by using an ASIC and by executing computer-executable instructions.

The network interface 1116 enables the computing environment 1102 to send and receive data from a communication network. The network interface 1116 can be implemented as an Ethernet interface, a token-ring network interface, a fiber optic network interface, a wireless network interface (e.g., Wi-Fi), or another type of network interface.

The external component interface 1118 enables the computing environment 1102 to communicate with external devices. For example, the external component interface 1118 can be a USB interface, Thunderbolt interface, a Lightning interface, a serial port interface, a parallel port interface, a PS/2 interface, or another type of interface that enables the computing environment 1102 to communicate with external devices. In various embodiments, the external component interface 1118 enables the computing environment 1102 to communicate with various external components, such as external storage devices, input devices, speakers, modems, media player docks, other computing devices, scanners, digital cameras, and fingerprint readers.

Although illustrated as being components of a single computing environment 1102, the components of the computing environment 1102 can be spread across multiple computing environments 1102. For example, one or more of instructions or data stored on the memory 1104 may be stored partially or entirely in a separate computing environment 1100 that is accessed over a network.

Depending on the size and scale of the computing environment 1102, it may be advantageous to include one or more load balancers to balance traffic across multiple physical or virtual machine nodes.

Aspects of the platform 1100 and the computing environment 1102 can be protected using a robust security model. In an example, users may be made to sign into the system using a directory service, such as ACTIVE DIRECTORY by MICROSOFT CORPORATION of Redmond, Washington. Connection and credential information can be externalized from jobs using an application programming interface. Credentials can be stored in an encrypted repository in a secured operational data store database space. Privileges can be assigned based on a collaboration team and mapped to a Lightweight Directory Access Protocol (LDAP) Group membership. A self-service security model can be used to allow owners to assign others permissions on their objects (e.g., actions).

Each node may be configured to be capable of running the full platform 1100, such that portal can run and schedule jobs and serve the portal user interface as long as a single node remains functional. The environment 1102 may include monitoring technology to determine when a node is not functioning so an appropriate action can be taken.

The memory device 106 typically includes at least some form of computer-readable media. By way of example, computer-readable media include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, blue ray discs, digital versatile discs or other optical storage, magnetic cassettes, magnetic tape, magnetic disk storage or other magnetic storage devices, or any other medium that can be used to store the desired information and that can be accessed by the processing device 104. In some embodiments, computer readable storage media is non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

Referring to FIGS. 1-9 generally, it is noted that the present methods and systems provide a number of advantages over existing advertising placement systems and other directed information delivery systems. For example, by mediating advertisements within a retail website by a retail enterprise in which the advertisements are selected from among those items that are available for purchase via the retail website directly, the retail enterprise is better able to control those advertisements that are displayed, limiting the displayed advertisements to those items which may be available and in stock. Since, within the retail webpages displayed herein, the advertisements may be made to appear in-line with search or category results, this ensures that display of such advertisements does not negatively affect a customer experience. Furthermore, by mediating such advertisements as received in the form of advertisement recommendations received from third party advertisement recommendation services using a weighted reverse index model, optimal advertisements are identified for display from among the filtered and relevant results. Accordingly, a retail enterprise need not itself identify advertisements for display, but may rely on third party advertisement recommendations while retaining control over which advertisements are ultimately displayed.

The above specification, examples and data provide a complete description of the manufacture and use of the composition of the invention. Since many embodiments of the invention can be made without departing from the spirit and scope of the invention, the invention resides in the claims hereinafter appended.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method comprising:
receiving, via a communication system, one or more advertisement requests at a computing system hosting an advertisement recommendation manager, the advertisement recommendation manager operated by a retail enterprise and associated with a retail website of the retail enterprise, the one or more advertisement requests each associated with a webpage of the retail website;
filtering, using a rules engine of the advertisement recommendation manager, the one or more advertisement requests by the computing system based at least in part on a context of the webpage to block at least one of the one or more advertisement requests;
acquiring, via an application programming interface (API), a plurality of advertisement recommendations from at least one third party advertising recommendation platform separate from the retail enterprise in response to submitting one or more filtered advertisement requests to the at least one third party advertising recommendation platform;
identifying, from among the plurality of advertisement recommendations, a plurality of available advertisements by the computing system, wherein identifying the plurality of available advertisements includes selecting advertisements from among the plurality of advertisement recommendations based at least in part on the context of the webpage and inventory status within inventory of the retail enterprise of items identified in the plurality of advertisement recommendations;
mediating, by the advertisement recommendation manager executing on the computing system of the retail enterprise, the plurality of available advertisements using a weighted reverse index model, the weighted reverse index model configured to be based on at least first data tracking a plurality of relevancy ranks and second data tracking a plurality of bid values, wherein each of the plurality of available advertisements corresponds to one of the plurality of relevancy ranks and one of the plurality of bid values; and
distributing, by the computing system and via the communication system, a predetermined number of selected advertisements to a customer system within a webpage of the retail enterprise in response to mediating the plurality of available advertisements the predetermined number corresponding to a number of available advertisement slots in the webpage corresponding to the one or more advertisement requests.

2. The method of claim 1, wherein the at least one third party advertising recommendation platform is selected from among a plurality of third party advertising recommendation platforms communicatively connected to the advertisement recommendation manager via the API.

3. The method of claim 1, wherein filtering the one or more advertisement requests further comprises identifying at least one advertisement identification number and blocking at least one advertisement request, the at least one advertisement request corresponding to the at least one advertisement identification number.

4. The method of claim 1, wherein selecting advertisements from among the plurality of advertisement recommendations is further based on inventory status within inventory at a particular retail location.

5. The method of claim 1, wherein mediating the plurality of available advertisements comprises:
receiving, by a mediation engine, first data tracking the plurality of relevancy ranks and second data tracking the plurality of bid values from the at least one advertising recommendation platform;
computing, by the mediation engine, a reverse index for each of the plurality of available advertisements based on a corresponding relevancy rank from the first data and a maximum count of advertisements from any one advertising recommendation platform;
computing, by the mediation engine, a weighted score for each of the plurality of available advertisements based on the reverse index and a corresponding bid value from the second data;
ranking the plurality of available advertisements based on the weighted score of each of the plurality of available advertisements; and
selecting, from the plurality of available advertisements, the predetermined number of selected advertisements according to a ranked plurality of weighted scores.

6. The method of claim 5, wherein mediating the plurality of available advertisements further comprises, when a first weighted score of a first available advertisement equals to a second weighted score of a second available advertisement, comparing a first reverse index of the first available advertisement with a second reverse index of the second available advertisement and ranking higher an advertisement of the first and second available advertisements that corresponds to the higher of the first and second reverse indices.

7. The method of claim 5, further comprising, when a first advertisement identification number of a first available advertisement equals to a second advertisement identification number of a second available advertisement, comparing a first weighted score of the first available advertisement with a second weighted score of the second available advertisement and removing whichever of the first and second available advertisements that corresponds to the lower of the first and second weighted scores.

8. The method of claim 5, further comprising:
receiving a floor bid value from a bid value system; and
removing at least one available advertisement, the at least one available advertisement corresponding to a bid value that is lower than the floor bid value.

9. The method of claim 1, further comprising adjusting the weighted reverse index model based on at least one search relevancy signal, the search relevancy signal relating to a search string of the customer system.

10. The method of claim 1, further comprising adjusting the weighted reverse index model based on user data, the user data relating to a signed-in status of the customer system.

11. A system comprising:
an input device;
a memory device;
a processing device in communication with the memory device; and
an output device,
wherein the processing device is operated by a retail enterprise and is configured to:
receive, via the input device, a plurality of advertisement requests associated with a webpage of a retail website for advertisements to be placed within the webpage, the plurality of advertisement requests being for items sold via the retail website;
filter, using a rules engine of an advertisement recommendation manager, the plurality of advertisement requests based at least in part on a context of the webpage to block at least one of the one or more advertisement requests;
acquire, via an application programming interface (API), a plurality of advertisement recommendations from at least one third party advertising recommendation platform separate from the retail enterprise in response to submitting one or more filtered advertisement requests to the at least one third party advertising recommendation platform, the at least one third party advertising recommendation platform being selected from among a plurality of third party advertising recommendation platforms communicatively connected to the advertisement recommendation manager via the API;
identify, from among the plurality of advertisement recommendations, a plurality of available advertisements, wherein identifying the plurality of available advertisements includes selecting advertisements from among the plurality of advertisement recommendations based at least in part on the context of the webpage and inventory status within inventory of the retail enterprise of items identified in the plurality of advertisement recommendations;
mediate, by the advertisement recommendation manager, the plurality of available advertisements using a weighted reverse index model, the weighted reverse index model configured to be based on at least first data tracking a plurality of relevancy ranks and second data tracking a plurality of bid values, wherein each of the plurality of available advertisements corresponds to one of the plurality of relevancy ranks and one of the plurality of bid values; and
distribute, via the output device, a predetermined number of selected advertisements to a customer system within a webpage of a retail website in response to mediating the plurality of available advertisements, the predetermined number corresponding to a number of available advertisement slots in the webpage corresponding to the one or more advertisement requests.

12. The system of claim 11, the processing device further configured to:
identify the webpage of the retail website to be displayed at a customer system;
block a portion of the plurality of advertisement requests, the portion of the plurality of advertisement requests having been requested for the webpage;
identify at least one advertisement identification number; and
block at least one advertisement request, the at least one advertisement request corresponding to the at least one advertisement identification number.

13. The system of claim 11, the processing device further configured to identify, from among the plurality of advertisement recommendations, a plurality of available advertisements from among the plurality of advertisement recommendations based on inventory status within inventory at a particular retail location.

14. The system of claim 11, the processing device further configured to:
receive, via the input device, first data tracking the plurality of relevancy ranks and second data tracking the plurality of bid values from the at least one third party advertising recommendation platform;
compute a reverse index for each of the plurality of available advertisements based on a corresponding relevancy rank from the first data and a maximum count of advertisements from any one third party advertising recommendation platform;
compute a weighted score for each of the plurality of available advertisements based on the reverse index and a corresponding bid value from the second data;
rank the plurality of available advertisements based on the weighted score of each of the plurality of available advertisements; and
select, from the plurality of available advertisements, the predetermined number of selected advertisements according to a ranked plurality of weighted scores.

15. The system of claim 14, the processing device further configured to:
when a first weighted score of a first available advertisement equals to a second weighted score of a second available advertisement, compare a first reverse index of the first available advertisement with a second reverse index of the second available advertisement and rank higher whichever of the first and second available advertisements that corresponds to the higher of the first and second reverse indices; and
when a first advertisement identification number of a first available advertisement equals to a second advertisement identification number of a second available advertisement, compare a first weighted score of the first available advertisement with a second weighted score of the second available advertisement and remove whichever of the first and second available advertisements that corresponds to the lower of the first and second weighted scores.

16. The system of claim 14, the processing device further configured to:
receive, via the input device, a floor bid value from a bid value system; and
remove at least one available advertisement, the at least one available advertisement corresponding to a bid value that is lower than the floor bid value.

17. The system of claim 11, the processing device further configured to adjust the weighted reverse index model based on at least one search relevancy signal, the search relevancy signal relating to a search string received at the retail website from the customer system.

18. The system of claim 11, the processing device further configured to adjust the weighted reverse index model based on user data, the user data relating to a signed-in status of the customer system.

19. A non-transitory computer-readable storage medium comprising computer-executable instructions which, when executed by a processing device of a computing system operated by a retail enterprise, cause the computing system to:
receive, via an input device, a plurality of advertisement requests associated with a webpage of a retail website for advertisements to be placed within the webpage, the plurality of advertisement requests being for items sold via the retail website;
filter, using a rules engine of an advertisement recommendation manager, the plurality of advertisement requests based at least in part on a context of the webpage to block at least one of the one or more advertisement requests;
acquire, via an application programming interface (API), a plurality of advertisement recommendations from at least one third party advertising recommendation platform separate from the retail enterprise in response to submitting one or more filtered advertisement requests to the at least one third party advertising recommendation platform, the at least one third party advertising recommendation platform being selected from among a plurality of third party advertising recommendation platforms communicatively connected to the advertisement manager via the API;
identify, from among the plurality of advertisement recommendations, a plurality of available advertisements, wherein identifying the plurality of available advertisements includes selecting advertisements from among the plurality of advertisement recommendations based at least in part on the context of the webpage and inventory status within inventory of the retail enterprise of items identified in the plurality of advertisement recommendations;
mediate, by the advertisement recommendation manager, the plurality of available advertisements using a weighted reverse index model, the weighted reverse index model configured to be based on at least first data tracking a plurality of relevancy ranks and second data tracking a plurality of bid values, wherein each of the plurality of available advertisements corresponds to one of the plurality of relevancy ranks and one of the plurality of bid values; and
distribute, via an output device, a predetermined number of selected advertisements to a customer system within a webpage of a retail website in response to mediating the plurality of available advertisements for display within a webpage of a retail website, the predetermined number corresponding to a number of available advertisement slots in the webpage corresponding to the one or more advertisement requests.

20. The non-transitory computer-readable storage medium of claim 19, further causing the computing system to:
receive, via the input device, first data tracking the plurality of relevancy ranks and second data tracking the plurality of bid values from the at least one third party advertising recommendation platform;
compute a reverse index for each of the plurality of available advertisements based on a corresponding relevancy rank from the first data and a maximum count of advertisements from any one third party advertising recommendation platform;
compute a weighted score for each of the plurality of available advertisements based on the reverse index and a corresponding bid value from the second data;
rank the plurality of available advertisements based on the weighted score of each of the plurality of available advertisements; and
select, from the plurality of available advertisements, the predetermined number of selected advertisements according to a ranked plurality of weighted scores.
